(19) United States
(12) Patent Application Publication
(10) Pub. No.: US 2005/0117872 A1
(43) Pub. Date: Jun. 2, 2005

(54) Computer system

(76) Inventors: Yu-Chih Liu, Linyuan Township (TW); Hui-Jen Peng, Lujhou City (TW); Mei-Hua Wang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/915,262

(22) Filed: Aug. 10, 2004

(30) Foreign Application Priority Data
Aug. 11, 2003 (TW) 92121960

(51) Int. Cl. H04N 5/76; H04N 5/781

(52) U.S. Cl. 386/46; 386/125

(57) ABSTRACT

A computer system. The computer system comprises a display device for image display, a storage device to store a video signal, and a video-playing subsystem, wherein power is supplied to the display device, the storage device, and the video-playing subsystem. The video-playing subsystem comprises a digital video recording (DVR) module to process the video signal transmitted from the storage device in a video-playing mode, and to output the audio signal and the image signal of the video signal respectively, and an image-processing module to process the image signal transmitted from the DVR module into an image for image display.

### BACKGROUND OF THE INVENTION

1. Field of the Invention

The present invention relates to a computer system, and more particularly to a computer system able to perform TV play, TV recording, video play and other functions when the computer system is not fully powered.

2. Description of the Related Art

For general computer systems, before playing a VCD in a VCD-ROM drive, an operating system and the application program of the VCD-ROM drive must be loaded in advance.

FIG. 1 illustrates the frame of a conventional computer system, comprising a processing device 102, a storage device 104 and a display device 106. The storage device 104, for example, is a hard disc or an optical recording medium, storing image data. After the computer system is fully powered, an operating system is loaded to control image data, and a video signal stored in the storage device 104 is transmitted to the display device 106 via the processing device 102. Without adequate power supply or complete loading of the operating system, the computer system cannot display the stored video signal which may be considered inconvenient.

To solve the problem, a computer system, capable of performing the above functions when it is not fully powered, has been provided. In the computer system, an additional operating subsystem only for image-data control is installed separately from the operating system. When the processing device is not adequately powered, the computer system executes the operating subsystem to play stored video. However, the operating subsystem must be written in advance into the memory of the computer system, and is hard to modify after being written. Owing to the regular update of the video-playing application program, the computer system cannot perform video playing functions without being fully powered if the written operating subsystem is not updated with the video-playing application program.

### SUMMARY OF THE INVENTION

Accordingly, an object of the present invention is to provide a computer system able to perform TV play, TV recording, video play, and other functions without an additional operating subsystem or full power supply.

Therefore, the invention provides a computer system which comprises a display device for image display, a storage device to store a video signal, and a video-playing subsystem, wherein a power is supplied to the display device, the storage device and the video-playing subsystem. The video-playing subsystem comprises a digital video recording (DVR) module to process the video signal transmitted from the storage device in video-playing mode, and output the audio signal and the image signal of the video signal respectively, and an image-processing module to process the image signal transmitted from the DVR module into an image for image display.

The computer system may further comprise a central processing device to load an operating system and control image data when the computer system is fully powered, wherein the central processing device transmits the video signal stored in the storage device to the DVR module of is the video-playing subsystem to process the video signal into an image for display.

The invention further provides a computer system which comprises a display device for image display, an audio-playing device to play an audio signal, a storage device having a storage medium for video signal storage, a video-playing subsystem, and a central processing device. The video-playing subsystem comprises a TV image module coupled to a TV signal receiving device to respectively output an audio signal and an image signal of a received TV signal during a TV play mode, and to simultaneously output the audio signal and the image signal of the received TV signal during a TV recording mode, a DVR module to output the audio signal from the TV image module to the audio-playing device during the TV play mode, storing the audio and image signals from the TV image module into the storage device during the TV recording mode, and processing the video signal from the storage device to respectively output an audio signal and an image signal of the video signal during a video-playing mode, wherein the audio signal is output to the audio-playing device, and an image-processing module to process the TV signal from the TV image module into an image for display by the display device during the TV play mode, and to process the image signal from the DVR module into an image for display by the display device during the video-playing mode The central processing device loads an operating system and controls image data when the computer system is fully powered, wherein the central processing device, controlling to play or to store the received TV signal in the TV image module, transmits the video signal stored in the storage device to the DVR module of the video-playing subsystem to process the video signal into an image for display. The computer system is not fully powered during the TV play mode, TV recording mode and the video-playing mode.

### DESCRIPTION OF THE DRAWINGS

The present invention can be more fully understood by reading the subsequent detailed description and examples with references made to the accompanying drawings, wherein:

FIG. 1 illustrates the frame of a conventional computer system;

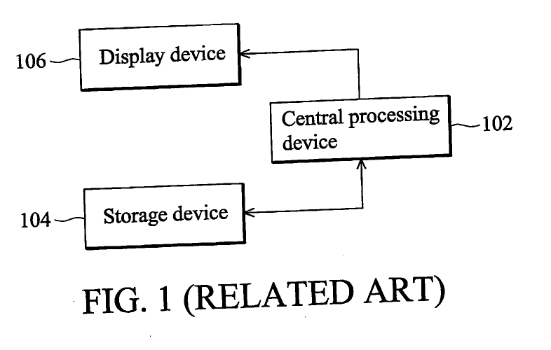

FIG. 2 illustrates the frame of a computer system in the first embodiment;

FIG. 3 illustrates the block diagram of a video-playing subsystem in the first embodiment;

FIG. 4 illustrates the frame of a computer system in the second embodiment; and

FIG. 5 illustrates the block diagram of a video-playing subsystem in the second embodiment.

### DETAILED DESCRIPTION OF THE INVENTION

### FIRST EMBODIMENT

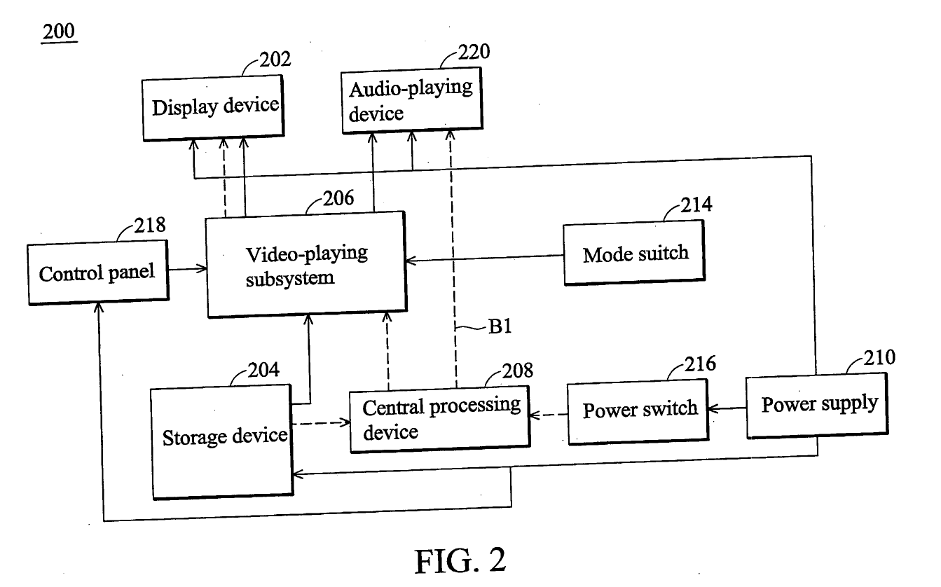

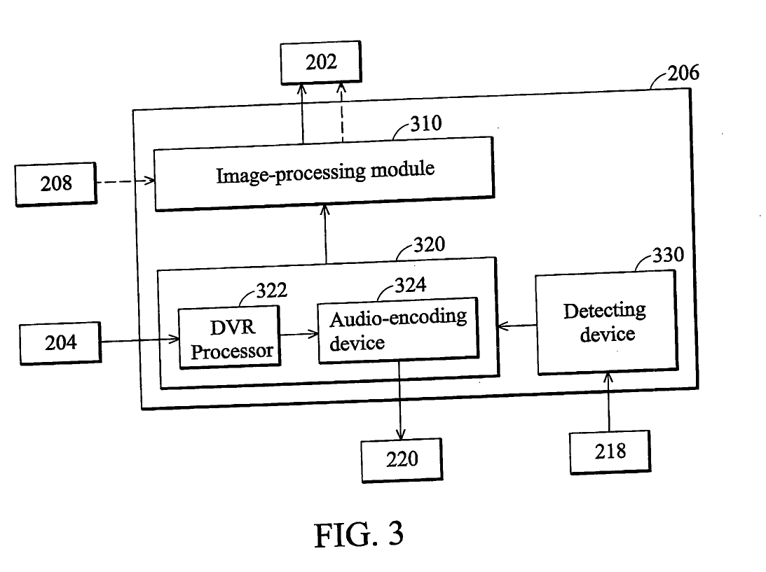

FIG. 2 illustrates the frame of a computer system in the first embodiment. The computer system 200 comprises a display device 202, a storage device 204, a video-playing subsystem 206, a central processing device 208, a power supply 210, a mode switch 214, a power switch 216, a control panel 218 and an audio-playing device 220. The storage device 204 is a hard disc or an optical disc drive able to access an optical recording medium for storing audio, image, or video signals. For example, the storage device 204 is an optical disc drive able to access a CD which records audio signals and a VCD which records audio and video signals; or a hard disc for storing JPEG files. When the power switch 216 is turned off, the power supply 210 only supplies power to the display device 202, storage device 204, video-playing subsystem 206, control panel 218, and the audio-playing device 220. In addition, the mode switch 214 is activated. Meanwhile, the status of the mode switch 214 is used to determine whether the computer system enters a video-playing mode or not: when the mode switch 214 is on the “on” status, the computer system enters the video-playing mode. During the video-playing mode, the video-playing subsystem 206 processes signals from the storage device 204. When the signals are video signals, the video-playing subsystem 206 processes them into images and audio signals and respectively displays them via the display device 202 and the audio-playing device 220. When the signals are image signals, the video-playing subsystem 206 displays them via the display device 202. The detailed operation of the video-playing subsystem 206 is shown in FIG. 3. The control panel 218 includes a plurality of control buttons to receive inputs from the user and perform various playing functions during a video-playing mode. The control buttons include a play button to play a CD or a VCD; a stop button to stop playing the CD or the VCD; a FF (fast forward) button to fast forward the CD or the VCD; a RW (rewind) button to rewind the CD or the VCD; a power button for the user to control the power supply 216; and a volume-controlling button to control the playing volume.

When the power switch 216 is turned on, the power supply 210 supplies the power to the entire computer system, including the display device 202, the storage device 204, the video-playing subsystem 206, the central processing device 208, the control panel 218, and audio-playing device 220. In FIG. 2, the solid lines indicate the power supplied from the power supply 210 to the central processing device 208, while the dashed lines is indicate the transmission of audio and image signals. Meanwhile, the mode switch 214 is switched to an “off” state, such that the computer system enters a normal operation mode to automatically load an operating system whereby the user can control the playing of the audio and image signals.

The display device 202 is for image display, such as an LCD or a CRT monitor. The storage device 204 is a normal hard disc or an optical disc drive able to access an optical recording medium. If the storage device 204 is a hard disc and the computer system is operated in a normal mode, the storage data is modifiable.

FIG. 3 illustrates the block diagram of the video-playing subsystem in the first embodiment. The video-playing subsystem 206 includes a DVR module 320, an image-processing module 310 and a detecting device 330.

During the video-playing mode, the video-playing subsystem 206 processes the signals from the storage device 204. When the signals are video signals, a DVR processor 322 of the DVR module 320 processes the video signals into respective audio and image signals. The audio signals are then transmitted to an audio-encoding device 324 of the DVR module 320. After the audio-encoding process, the audio signals are transmitted to an audio output device 220, for example, a speaker. The image signals are transmitted to the image-processing is module 310 to form an image for display on the display device 202.

When the signals are audio signals, the DVR processor 322 directly transmits the audio signals to the audio-encoding device 324 and outputs via the audio output device 220 after audio-encoding.

When the signals are image signals, the DVR processor 322 directly transmits the image signals to the image-processing module 310 and outputs via the display device 202 after image processing.

The detecting device 330 is used to detect the control buttons on the control panel 218, and to control the DVR module 320 to perform various functions during the video-playing mode.

Once the computer system enters the normal operation mode, the system automatically loads the operating system, and the playing of image or audio signals is controlled by the central processing device 208. Before playing images, the central processing device 208 transmits the video or image signals from the storage device 204 to the image-processing module 310 of the video-playing subsystem 206 and displays images on the display device 202 (as shown by the dashed lines). Before playing audio signals, the central processing device 208 transmits the audio signals from the storage device 204 to the audio output device 220 (as shown by the dashed line B1 in FIG. 2).

In the embodiment, the detecting device detects the control buttons on the control panel to control the DVR module. In other embodiments, the user can control the DVR module by transmitting wireless controlling signals from a remote controller (not shown) to perform various playing functions. In the case, a signal detecting device with different function will be applied to replace the detecting device.

### SECOND EMBODIMENT

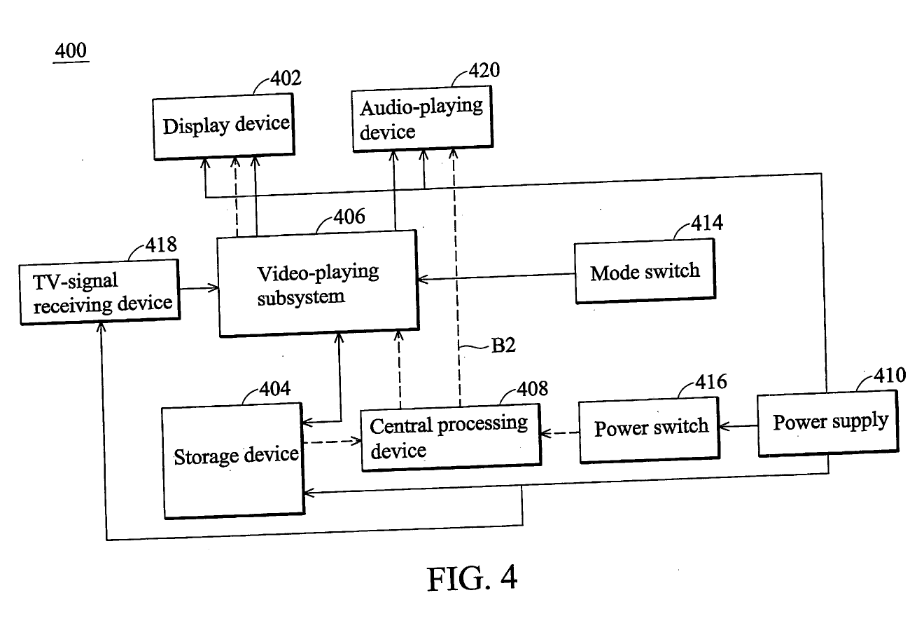

FIG. 4 illustrates the frame of a computer system in the second embodiment. The computer system 400 comprises a display device 402, a storage device 404, a video-playing subsystem 406, a central processing device 408, a power supply 410, a mode switch 414, a power switch 416, a control panel 418 and an audio-playing device 420. The storage device 404 is a hard disc or an optical recording medium for storing audio, image, or video signals. For example, the storage device 404 is a CD for storing audio signals, a VCD for storing video signals, or a hard disc for storing JPEG files.

When the power switch 416 is turned off, the power supply 410 only supplies power to the display device 402, storage device 404, video-playing subsystem 406, control panel 418, and the audio-playing device 420. In addition, the mode switch 414 is activated. Meanwhile, the status of the mode switch 414 is used to determine the operation mode of the computer system, for example, the video-play mode, TV play mode or the TV recording mode. The user can control the operating mode of the computer system by transmitting controlling signals from a remote controller (not shown).

If the computer system 400 enters the video-playing mode, the video-playing subsystem 406 processes signals from the storage device 404. When the signals are video signals, the video-playing subsystem 406 processes them into images and audio signals and respectively outputs them via the display device 402 and the audio-playing device 420. When the signals are image signals, the video-playing subsystem 406 display them via the display device 402. When the signals are audio signals, the video-playing subsystem 406 play them via the audio-playing device 420.

If the computer system 400 enters the TV play mode, the video-playing subsystem 406 processes TV signals from the TV-signal receiving device 418. The video-playing subsystem 406 processes them into images and audio signals and respectively outputs them via the display device 402 and the, audio-playing device 420.

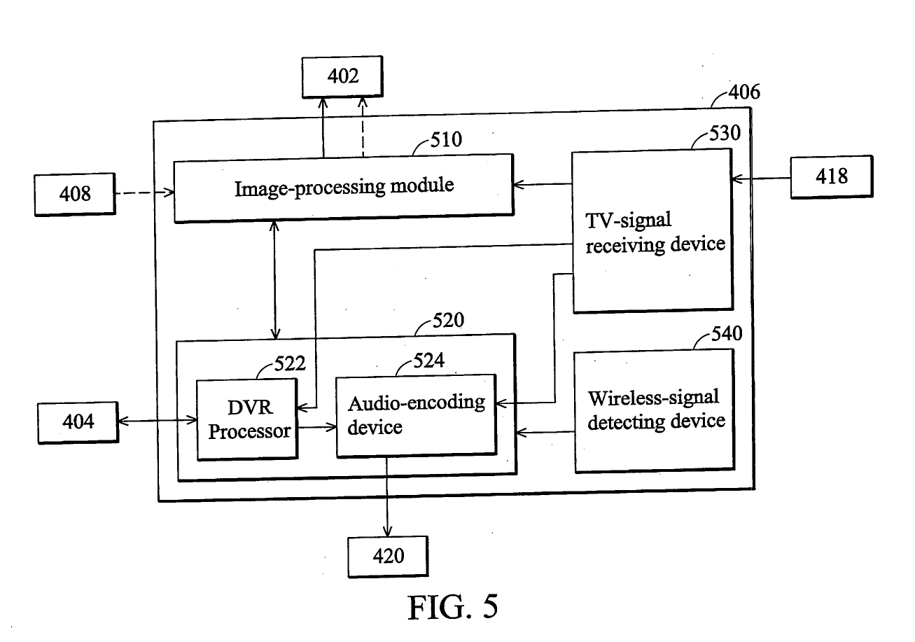

If the computer system 400 enters the TV recording mode, the video-playing subsystem 406 processes TV signals from the TV-signal receiving device 418. The video-playing subsystem 406 simultaneously stores the image and audio signals of the TV signals into the storage device 404. The detailed operation of the video-playing subsystem 406 is shown in FIG. 5.

When the power switch 416 is turned on, the power supply 410 supplies the power to the entire computer system, including the display device 402, the storage device 404, the video-playing subsystem 406, the central processing device 408, the control panel 418 and audio-playing device 420. In FIG. 4, the solid lines indicate the power supplied from the power supply 410 to the central processing device 408, while the dashed lines indicate the transmission of audio and image signals. Meanwhile, the status of the mode switch 414 is turned to be “off”, such that the computer system enters a normal operation mode to automatically load an operating system whereby the user can control the playing of the audio and image signals.

The display device 402 is for image display, such as an LCD or a CRT monitor. The storage device 404 is a normal hard disc or an optical recording medium. If the storage device 404 is a hard disc and the computer system is operated in a normal mode, the storage data is modifiable.

FIG. 5 is a block diagram illustrating the video-playing subsystem in the second embodiment. The video-playing subsystem 406 includes a DVR module 520, an image-processing module 510, a TV image module 530 and a wireless-signal detecting device 540.

During the video-playing mode, the video-playing subsystem 506 processes the signals from the storage device 504. When the signals are video signals, a DVR processor 522 of the DVR module 520 processes the video signals into respective audio and image signals. The audio signals are then transmitted to an audio-encoding device 524 of the DVR module 520. After audio-encoding process, the audio signals are transmitted to an audio output device 420, for example, a speaker. The image signals are transmitted to the image-processing module 510 to form an image for display on the display device 402.

When the signals are audio signals, the DVR processor 522 directly transmits the audio signals to the audio-encoding device 524 and outputs via the audio output device 420 after audio-encoding.

When the signals are image signals, the DVR processor 522 directly transmits the image signals to the image-processing module 510 and outputs via the display device 402 after image processing.

During the TV play mode, the TV image module 530 processes the TV signals from the TV-signal receiving device 418 into audio signals and image signals. The audio signals are then transmitted to the audio-encoding device 524 of the DVR module 520. After audio-encoding process, the audio signals are transmitted to the audio output device 420. The image signals are transmitted to the image-processing module 510 to form an image for display on the display device 402.

During the TV recording mode, the TV image module 530 processes the TV signals from the TV-signal receiving device 418 and simultaneously transmits the audio and image signals of the TV signals to the DVR processor 522, and then store them in the storage device 404.

The wireless-signal detecting device 540 is used to detect the wireless signals transmitted from a remote controller (not shown) to control the DVR module 320 and perform various functions. The remote controller has a plurality of control buttons to receive the user's input and transmits various wireless signals to the wireless detecting device 540. The control buttons include a play button to play a CD or a VCD; a stop button to stop playing the CD or the VCD; a FF (fast forward) button to fast forward the CD or the VCD; a RW (rewind) button to rewind the CD or the VCD; a power button for the user to control the power supply 416; a mode-selecting button to select the operation mode of the computer system 400 by the mode switch 414; and a volume-controlling button to control the playing volume.

Once the computer system enters the normal operation mode, the system automatically loads the operating system, and the playing of image or audio signals is controlled by the central processing device 408. Before playing images, the central processing device 408 transmits the video or image signals from the storage device 404 to the image-processing module 510 of the video-playing subsystem 406 and display images on the display device 402 (as shown by the dashed lines). Before playing audio signals, the central processing device 508 transmits the audio signals from the storage device 404 to the audio output device 420 (as shown by the dashed line B2 in FIG. 5). Furthermore, the TV image module 530 processes the TV signals from the TV-signal receiving device 418 in a normal operation mode, but the processed TV signals are controlled by the central processing device 408.

In the embodiment, the wireless-signal detecting device detects the wireless controlling signals transmitted from a remote controller. In other embodiments, the user can control the DVR module by transmitting other controlling signals. In the case, a signal detecting device with different function will be applied to replace the wireless-signal detecting device.

According to the invention, the inventive computer system is able to perform TV play, TV recording, video play and other functions without full powered and additional operating subsystem, which is beneficial for the user.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A computer system, comprising:
a display device for image display;
a storage device to store a video signal; and
a video-playing subsystem, comprising:
a digital video recording (DVR) module to process the video signal transmitted from the storage device in a video-playing mode, and to output the audio signal and the image signal of the video signal respectively; and
an image-processing module to process the image signal transmitted from the DVR module into an image for image display,
wherein a power is supplied to the display device, the storage device and the video-playing subsystem.

2. The computer system as claimed in claim 1, further comprising a central processing device to load an operating system and control image data when the computer system is fully powered, wherein the central processing device transmits the video signal stored in the storage device to the DVR module of the video-playing subsystem to process the video signal into an image for display.

3. The computer system as claimed in claim 1, further comprising a control panel having a plurality of control buttons for various playing functions during the video-playing mode.

4. The computer system as claimed in claim 3, wherein the video-playing subsystem further comprises a detecting device to detect the control buttons during the video-playing mode for various playing functions.

5. The computer system as claimed in claim 1, wherein the video-playing subsystem further comprises a wireless signal detecting device to detect a plurality of wireless signals during the video-playing mode for various playing functions.

6. The computer system as claimed in claim 1, further comprises an audio-playing device to play the audio signal transmitted from the DVR module.

7. The computer system as claimed in claim 6, wherein video-playing subsystem further comprises:
a TV image module coupled to a TV signal receiving device to respectively output an audio signal, and an image signal of a received TV signal during a TV play mode and to simultaneously output the audio signal and the image signal of the received TV signal during a TV recording mode,
wherein the DVR module outputs the audio signal transmitted from the TV image module to the audio-playing device during the TV play mode, storing the audio and image signals from the TV image module into the storage device during the TV recording mode, and processing the TV signal from the TV image module into an image for display by the display device during the TV play mode.

8. The computer system as claimed in claim 7, further comprises a control panel having a switch button and a plurality of control buttons, wherein the switch button is for switching among the TV play mode, TV recording mode and the video-playing mode, while the control buttons are for various playing functions during the TV play mode, TV recording mode and the video-playing mode.

9. The computer system as claimed in claim 7, wherein the video-playing subsystem further comprises a detecting device to detect a control signal entered by the control panel for switching among the TV play mode, TV recording mode and the video-playing mode or for various playing functions during the TV play mode, TV recording mode and the video-playing mode.

10. The computer system as claimed in claim 7, wherein the video-playing subsystem further comprises a wireless signal detecting device to detect a plurality of wireless control signals for various playing functions during the TV play mode, TV recording mode and the video-playing mode.

11. The computer system as claimed in claim 7, wherein the computer system enters the TV play mode, TV recording mode or the video-playing mode without loading an operating system.

12. The computer system as claimed in claim 1, wherein the computer system enters the video-playing mode without loading an operating system.

13. A computer system, comprising:
a display device for image display;
an audio-playing device to play an audio signal;
a storage device for a video signal storage; and
a video-playing subsystem, comprising:
a TV image module coupled to a TV signal receiving device to respectively output an audio signal and an image signal of a received TV signal during a TV play mode, and to simultaneously output the audio signal and the image signal of the received TV signal during a TV recording mode;
a DVR module to output the audio signal from the TV image module to the audio-playing device during the TV play mode, storing the audio and image signals from the TV image module into the storage device during the TV recording mode, and processing the video signal from the storage device to respectively output an audio signal and an image signal of the video signal during a video-playing mode, wherein the audio signal is output to the audio-playing device; and
an image-processing module to process the TV signal from the TV image module into an image for display by the display device during the TV play mode, and to process the image signal from the DVR module into an image for display by the display device during the video-playing mode;
a central processing device to load an operating system and control image data when the computer system is fully powered, wherein the central processing device, controlling to play or to store the received TV signal in the TV image module, transmits the video signal stored in the storage device to the DVR module of the video-playing subsystem to process the video signal into an image for display,
wherein the computer system is not fully powered during the TV play mode, TV recording mode and the video-playing mode.

14. The computer system as claimed in claim 13, further comprises a control panel having a switch button and a plurality of control buttons, wherein the switch button is for switching among the TV play mode, TV recording mode and the video-playing mode, while the control buttons are for various playing functions during the TV play mode, TV recording mode and the video-playing mode.

15. The computer system as claimed in claim 14, wherein the video-playing subsystem further comprises a detecting device to detect a control signal entered by the control panel for switching among the TV play mode, TV recording mode and the video-playing mode or for various playing functions during the TV play mode, TV recording mode and the video-playing mode.

16. The computer system as claimed in claim 13, wherein the video-playing subsystem further comprises a wireless signal detecting device to detect a plurality of wireless control signals for various playing functions during the TV play mode, TV recording mode and the video-playing mode.

17. The computer system as claimed in claim 13, wherein the computer system enters the TV play mode, TV recording mode or the video-playing mode without loading an operating system.
